(19) United States
(12) Patent Application Publication
(10) Pub. No.: US 2022/0057518 A1
(43) Pub. Date: Feb. 24, 2022

(54) CAPTURING ENVIRONMENTAL SCANS USING SENSOR FUSION

(71) Applicant: FARO Technologies, Inc., Lake Mary, FL (US)

(72) Inventors: Mark Brenner, Asperg (DE); Aleksej Frank, Kornwestheim (DE); Oliver Zweigle, Stuttgart (DE); Ahmad Ramadneh, Kornwestheim (DE)

(21) Appl. No.: 17/325,940

(22) Filed: May 20, 2021

Related U.S. Application Data
(60) Provisional application No. 63/067,377, filed on Aug. 19, 2020.

(51) Int. Cl. G01S 17/894; G01S 17/42; G01S 7/48; G01S 7/497

(52) U.S. Cl. CPC G01S 17/894; G01S 7/497; G01S 7/4808; G01S 17/42

(57) ABSTRACT

Techniques are described to determine a constraint for performing a simultaneous location and mapping. A method includes detecting a first set of planes in a first scan-data of an environment, and detecting a second set of planes in a second scan-data. Further, a plane that is in the first set of planes and the second set of planes is identified. Further, a first set of measurements of a landmark on the plane is determined from the first scan-data, and a second set of measurements of said landmark is determined from the second scan-data. The constraint is determined by computing a relationship between the first set of measurements and the second set of measurements.

### CROSS REFERENCE TO RELATED APPLICATIONS

This application claims the benefit of U.S. Provisional Application Ser. No. 63/067,377, filed Aug. 19, 2020, the entire disclosure of which is incorporated herein by reference.

### BACKGROUND

Embodiments of the present invention generally relate to acquiring three-dimensional coordinates of points on a surface of an object and, in particular, to a system and method of operating a laser scanner to track the position and orientation of the scanner device during operation.

The acquisition of three-dimensional coordinates of an object or an environment is known. Various techniques may be used, such as time-of-flight (TOF) or triangulation methods, for example. A TOF system such as a laser tracker, for example, directs a beam of light such as a laser beam toward a retroreflector target positioned over a spot to be measured. An absolute distance meter (ADM) is used to determine the distance from the distance meter to the retroreflector based on the length of time it takes the light to travel to the spot and return. By moving the retroreflector target over the surface of the object, the coordinates of the object surface may be ascertained. Another example of a TOF system is a laser scanner that measures a distance to a spot on a diffuse surface with an ADM that measures the time for the light to travel to the spot and return. TOF systems have advantages in being accurate, but in some cases may be slower than systems that project a plurality of light spots onto the surface at each instant in time.

In contrast, a triangulation system, such as a scanner, projects either a line of light (e.g., from a laser line probe) or a pattern of light (e.g., from a structured light) onto the surface. In this system, a camera is coupled to a projector in a fixed mechanical relationship. The light/pattern emitted from the projector is reflected off of the surface and detected by the camera. Since the camera and projector are arranged in a fixed relationship, the distance to the object may be determined from captured images using trigonometric principles. Triangulation systems provide advantages in quickly acquiring coordinate data over large areas.

In some systems, during the scanning process, the scanner acquires, at different times, a series of images of the patterns of light formed on the object surface. These multiple images are then registered relative to each other so that the position and orientation of each image relative to the other images are known. Where the scanner is handheld, various techniques have been used to register the images. One common technique uses features in the images to match overlapping areas of adjacent image frames. This technique works well when the object being measured has many features relative to the field of view of the scanner. However, if the object contains a relatively large flat or curved surface, the images may not properly register relative to each other.

Accordingly, while existing 3D scanners are suitable for their intended purposes, what is needed is a 3D scanner having certain features of embodiments of the present invention.

### BRIEF DESCRIPTION

A system includes an image capture device, a light detection and ranging (LIDAR) device, and one or more processors operably coupled to the image capture device and the LIDAR device. The one or more processors are operable to capture a first scan-data of the surrounding environment from a first position, and capture a second scan-data of the surrounding environment from a second position, wherein the first scan-data comprises a first image from the image capture device and a first distance-data from the LIDAR device, and the second scan-data comprises a second image from the image capture device and a second distance-data from the LIDAR device. The one or more processors are further operable to detect a first set of planes in the first scan-data by projecting the first distance-data on the first image. The one or more processors are further operable to detect a second set of planes in the second scan-data by projecting the second distance-data on the second image. The one or more processors are further operable to identify a plane that is in the first set of planes and the second set of planes by matching the first set of planes and the second set of planes. The one or more processors are further operable to determine a first set of measurements of a landmark on the plane, the first set of measurements determined from the first scan-data. The one or more processors are further operable to determine a second set of measurements of said landmark on said plane, the second set of measurements determined from the second scan-data. The one or more processors are further operable to determine a constraint by computing a relationship between the first set of measurements and the second set of measurements. The one or more processors are further operable to perform a simultaneous location and mapping by using the constraint.

Further, the one or more processors are operable to assign a unique identifier to the plane. Alternatively, or in addition, the one or more processors are operable to perform a loop closure using the plane as part of a set of planes. Performing the loop closure includes determining an error based on the first set of measurements and the second set of measurements, and adjusting a third scan-data based on the error.

Further, the system captures scan-data at a predetermined frequency. The system is moved through the surrounding at a predetermined speed.

The plane is identified automatically in one or more embodiments.

In one or more embodiments, a method for performing a simultaneous location and mapping using data fusion includes capturing a first scan-data of the surrounding environment from a first position, and capture a second scan-data of the surrounding environment from a second position, wherein the first scan-data comprises a first image from an image capture device and a first distance-data from a LIDAR device, and the second scan-data comprises a second image from the image capture device and a second distance-data from the LIDAR device. The method further includes detecting a first set of planes in the first scan-data by projecting the first distance-data on the first image. The method further includes detecting a second set of planes in the second scan-data by projecting the second distance-data on the second image. The method further includes identifying a plane that is in the first set of planes and the second set of planes by matching the first set of planes and the second set of planes. The method further includes determining a first set of measurements of a landmark on the plane, the first set of measurements determined from the first scan-data. The method further includes determining a second set of measurements of said landmark on said plane, the second set of measurements determined from the second scan-data. The method further includes determining a constraint by computing a relationship between the first set of measurements and the second set of measurements. The method further includes performing the simultaneous location and mapping by using the constraint.

Alternatively, or in addition, in another embodiment, a non-transitory computer-readable medium has program instructions embodied therewith, the program instructions readable by a processor to cause the processor to perform the method for performing a simultaneous location and mapping using data fusion.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a system for scanning an environment according to one or more embodiments of the present disclosure;

FIG. 2 depicts a flowchart of a method for using sensor data fusion for tracking a scanner device while simultaneously capturing a scan of the environment according to one or more embodiments of the present disclosure;

FIG. 3 depicts an example view captured by the cameras from the set of sensors;

FIG. 4 depicts an example view that includes detected planes and their respective plane-normals in the view from FIG. 3;

FIG. 5 depicts a diagram of matching planes from one frame with another according to one or more embodiments of the present disclosure;

FIG. 6 depicts a graphical representation of an example SLAM implementation;

FIG. 7 depicts a real-world example scenario implementing the technical features provided by one or more embodiments of the present disclosure;

FIG. 8 is a perspective view of a laser scanner in accordance with an embodiment of the disclosure;

FIG. 9 is a perspective view of a laser scanner in accordance with an embodiment of the disclosure;

FIG. 10 is a block diagram of a laser scanner in accordance with an embodiment of the disclosure;

FIG. 11 is a perspective view of scanners mounted on a platform to capture an environment in accordance with an embodiment of the disclosure;

FIG. 12 is a perspective view of scanners mounted on a platform to capture an environment in accordance with an embodiment of the disclosure;

FIG. 13 is a block diagram of a laser scanner in accordance with an embodiment of the disclosure; and

FIG. 14 illustrates a computing system according to one or more embodiments of the presentdisclosure.

The detailed description explains embodiments of the invention, together with advantages and features, by way of example, with reference to the drawings.

### DETAILED DESCRIPTION

Embodiments of the present invention provide technical solutions to technical challenges in existing environment scanning systems. The scanning systems can capture two-dimensional or three-dimensional (3D) scans. Such scans can include 2D maps, 3D point clouds, or a combination thereof. The scans can include additional components, such as annotations, images, textures, measurements, and other details.

Typically, when capturing a scan of an environment, a version of the simultaneous localization and mapping (SLAM) algorithm is used. For completing such scans a scanner, such as the FARO® SCANPLAN®, FARO® SWIFT®, or any other scanning system incrementally builds the scan of the environment, while the scanner is moving through the environment, and simultaneously the scanner tries to localize itself on this scan that is being generated. An example of a handheld scanner is described in U.S. patent application Ser. No. 15/713,931, the contents of which is incorporated by reference herein in its entirety. This type of scanner may also be combined with a another scanner, such as a time of flight scanner as is described in commonly owned U.S. patent application Ser. No. 16/567,575, the contents of which are incorporated by reference herein in its entirety. It should be noted that the scanners listed above are just examples and that the type of scanner used in one or more embodiments of the present invention does not limit the features of the technical solutions described herein.

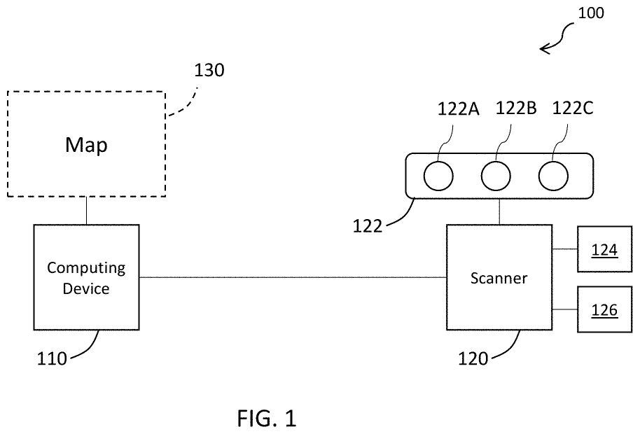

FIG. 1 depicts a system for scanning an environment according to one or more embodiments of the present invention. The system 100 includes a computing system 110 coupled with a scanner 120. The coupling facilitates wired and/or wireless communication between the computing system 110 and the scanner 120. The scanner 120 includes a set of sensors 122. The set of sensors 122 can include different types of sensors, such as LIDAR 122A (light detection and ranging), RGB-D camera 122B (red-green-blue-depth), and fisheye camera 122C, and other types of sensors. The scanner 120 can also include an inertial measurement unit (IMU) 126 to keep track of a 3D orientation of the scanner 120. The scanner 120 can further include a processor 124 that, in turn, includes one or more processing units. The processor 124 controls the measurements performed using the set of sensors 122. In one or more examples, the measurements are performed based on one or more instructions received from the computing system 110. In an embodiment, the LIDAR sensor 122A is a two-dimensional (2D) scanner that sweeps a line of light in a plane (e.g. a plane horizontal to the floor).

The computing system 110 can be a desktop computer, a laptop computer, a tablet computer, a phone, or any other type of computing device that can communicate with the scanner 120.

In one or more embodiments, the computing device 110 and/or a display (not shown) of the scanner 120 provides a live view of the “map” 130 of the environment being scanned by the scanner 120 using the set of sensors 122. Map 130 can be a 2D or 3D representation of the environment seen through the different sensors. Map 130 can be represented internally as a grid map. A grid map is a 2D or 3D arranged collection of cells, representing an area of the environment. In one or more embodiments of the present invention, the grid map stores for every cell, a probability indicating if the cell area is occupied or not. Other representations of the map 130 can be used in one or more embodiments of the present invention. It should be noted that the map 130 is a representation of a portion of the environment and that the scan of the environment includes several such maps “stitched” together. Stitching the maps together includes determining one or more landmarks on each map 130 that is captured and aligning and registering the maps 130 with each other to generate the scan. In an embodiment, the map 130 may be a point cloud or collection of three-dimensional coordinates in the environment.

As noted earlier, the scanner 120, along with capturing the map 130, is also locating itself within the environment. In an embodiment, the scanner 120 uses odometry, which includes using data from motion or visual sensors to estimate the change in position of the scanner 120 over time. Odometry is used to estimate the position of the scanner 120 relative to a starting location. This method is sensitive to errors due to the integration of velocity measurements over time to give position estimates, which generally applies to odometry from inertial measurements. In other embodiments, the scanner 120 estimates its position based only on visual sensors.

In addition, each sensor from the set of sensors 122 has technical problems when it is used for determing the position of the scanner 120 in the environment. For example, LIDAR data cannot be matched properly in 3D because successive data-captures from the LIDAR 122A do not have an overlap with the 3D data that facilitates determining landmarks for aligning and registration. Further, because the LIDAR 122A provides data that is captured only along a line of sight, which can be tilted (or offset in any other way) in comparison to earlier data-capture, the alignment of such captured data cannot be performed.

Further, in the case of the RGB-D camera 122B, in some environments (e.g., a hallway with white walls), a number of features that are captured in the images with depth due to the field of view of the camera 122B do not facilitate tracking a position of the scanner 120, and/or aligning and registering images. Such a lack of identifiable features can result in misalignment in captured images. Similar challenges exist with other types of cameras, such as fisheye cameras.

The technical solution provided by one or more embodiments of the present invention facilitates combining the data-captured by the set of sensors 122 by fusing such data into planes. Such fusion facilitates to overcome the technical challenges of each individual type of sensor and further facilitates to generate an accurate trajectory for the SLAM implementation. One or more embodiments of the present invention provide an improved trajectory for implementing SLAM by incorporating at least one LIDAR 122A, and at least one RGB-D camera 122B. The scanner 120 can also include a stereo fisheye camera system 122C. The fisheye camera system can include more than two cameras in one or more embodiments.

Using the LIDAR 122A and the RGB-D camera 122B to generate dense depth during movement can be technically challenging. The LIDAR matches do not work very well once the scanner 120 is moved in 3D space even with an IMU 126 because the number of matches is fewer than a predetermined threshold and due to accuracy limitations of sensors within the IMU. Further, because of the limited field of view of the RGB-D camera 122B using the captures from the RGB-D camera 122B suffers from a tendency to lose tracking of the scanner 120 and having a drift over the movement of the scanner (e.g., movement more than 5 meters) when the number of features in the captured images is lower than a predetermined threshold. It is understood that above described examples of measurements can vary from one embodiment to another.

Embodiments of the present disclosurefacilitate fusing the data-captured by the RGB-D camera 122B and by the LIDAR 122A identifying and using planes in 3D space for such combining and further adding constraints for the trajectory estimation of the scanner 120. Embodiments of the present disclosure, accordingly, facilitate using the RGB-D camera 122B with feature tracking for visual odometry and adding more information to the visual odometry to improve the accuracy of the SLAM result.

The embodiments of the present invention, facilitate improvement to computing technology, and particularly to techniques used for scanning an environment using 2D/3D scanners. Further, embodiments of the present invention provide a practical application that facilitates generating a scan of an environment.

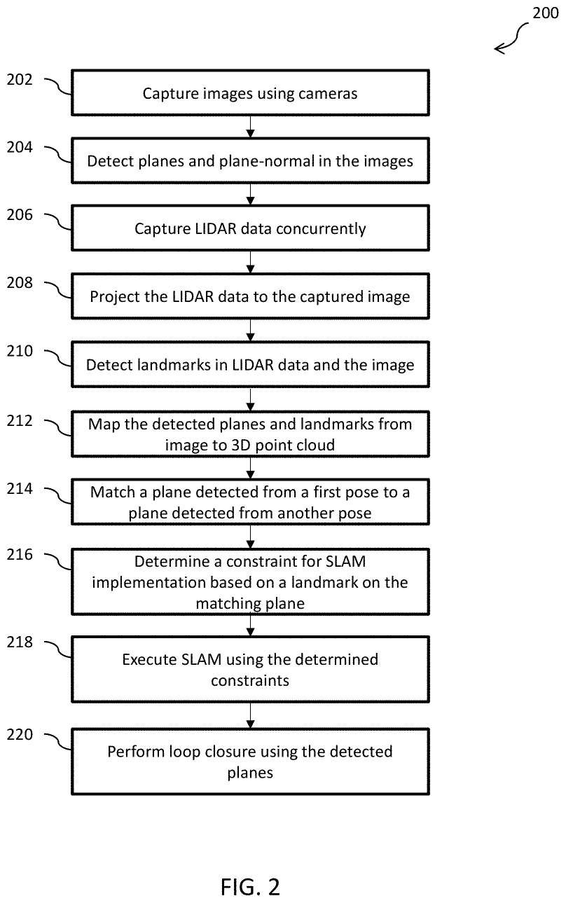

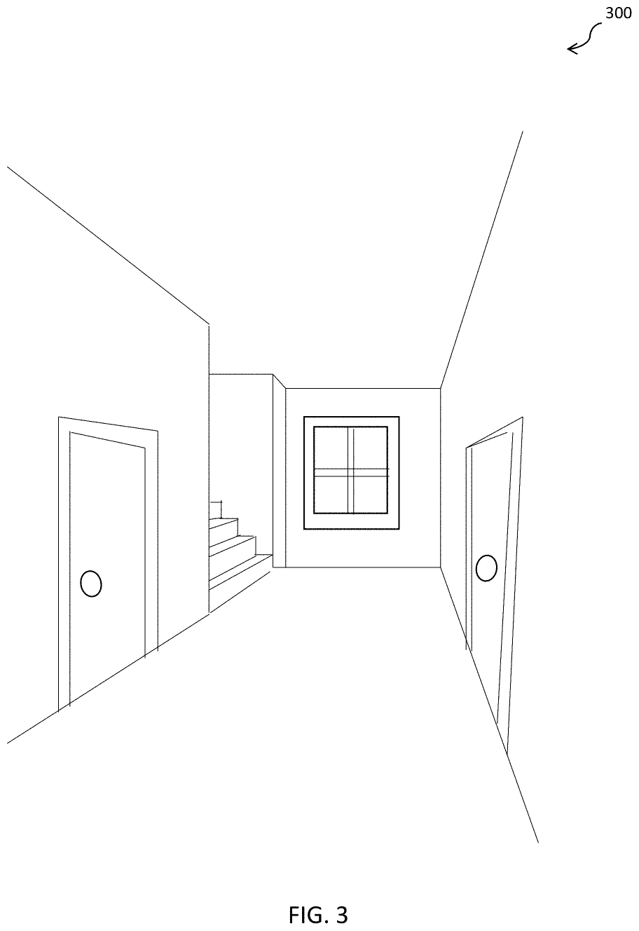

FIG. 2 depicts a flow chart of a method for using sensor data fusion for tracking a scanner device while simultaneously capturing a scan of the environment according to one or more embodiments of the present disclosure. The method 200 includes capturing images using the RGB-D camera 122B and the stereoscopic (or fisheye) camera 122C, at block 202. The images are captured in a continuous manner at a predetermined frequency in one or more embodiments of the present disclosure. Alternatively, or in addition, an image can be captured in response to a user command, for example, via the scanner 120 or the computing system 110, etc. Each image includes color information along with depth information, for example, captured by the RGB-D camera 122B, at each pixel of the image. FIG. 3 depicts an example view 300 captured by the cameras from the set of sensors 122.

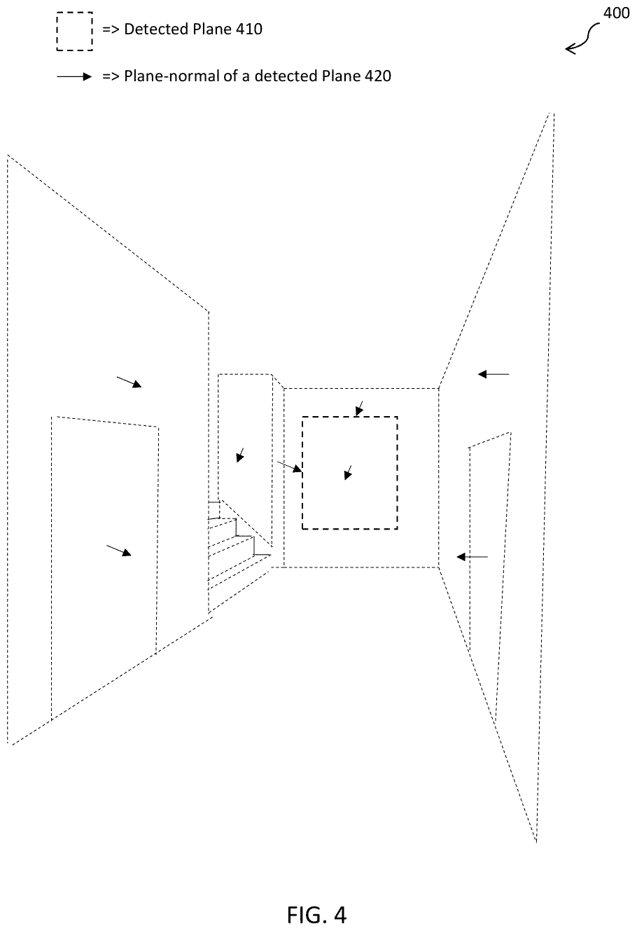

The method 200 further includes automatically detecting planes in the captured images, at block 204. The planes can be detected by the processor 124 or the computing device 110. For example, the planes are detected using machine learning, such as a neural network available using application programming interfaces via libraries like ARCORE®. The planes can also be detected using algorithms like region growing, which do not use machine learning. Detecting a plane can further include determining an estimation of a plane-normal for each plane that is detected. FIG. 4 depicts an exemplary view 400 that includes detected planes 410 and their respective plane-normals 420 that are detected in the view 300 from FIG. 3.

The method 200 also includes capturing data from the LIDAR 122A concurrently with the cameras, at block 206. The method 200 further includes projecting the LIDAR data and the depth data to the 2D image, at block 208. In one or more embodiments of the present disclosure, the LIDAR data is sampled prior to projecting the data onto the image. In one or more embodiments of the present disclosure, the LIDAR data that is projected on the image is captured over multiple frames. Here, a “frame” is a collection of data captured by the fisheye camera 122C and the camera. In one or more embodiments of the present disclosure, the fisheye camera 122C can be replaced by the stereoscopic camera (which includes two or more cameras to capture 3D data). Here, the “frame” includes the images captured by all the cameras that are part of the stereoscopic camera.

It should be noted that LIDAR data includes 3D point clouds, and the image captured by the RGB-D camera 122B includes pixels, which are points in 3D or on a 2D plane. In the LIDAR data, each point from the 3D point cloud encodes XYZ coordinates and a reflectance value. The image, in the case of 3D data, also includes XYZ coordinates and color value. In the case of the 2D image, the image includes XY coordinates and color values. Accordingly, projecting the LIDAR data onto the image includes mapping the XYZ coordinates in the LIDAR data to the coordinates in the image. The mapping is performed based on a calibration between the LIDAR 122A and the camera 122B.

Further, the method includes detecting features in the 3D point cloud from the LIDAR data and the image from the cameras, at block 210. Here, a “feature” is a landmark that can be used to register a 3D point cloud with another 3D point cloud or to register an image with another image. Here, the registration can be done by detecting the same landmark in the two images (or point clouds) that are to be registered with each other. A feature can include landmarks such as a doorknob (310), a door (320), a lamp (not shown), a fire extinguisher (not shown), or any other such identification mark that is not moved during the scanning of the environment. The landmarks can also include stairs, windows, decorative items (e.g., plant, picture-frame, etc.), furniture, or any other such structural or stationary objects.

The method 200 further includes mapping the detected contours of the planes and landmarks from the image with the 3D point cloud and the landmarks from the LIDAR data, at block 212. In one or more embodiments, only mapping the planes to the 3D point cloud facilitates obtaining a precise position. The mapping can be done manually by a user in one or more embodiments of the present invention. Alternatively, or in addition, an autonomous process can be used that detects the landmarks in the image and in the point cloud.

Further, for mapping the planes with the point cloud, edge detection is performed in the two datasets (image, and point cloud). In one or more embodiments of the present disclosure, mapping the planes 410 to the point cloud can include using a robust algorithm, such as RANSAC (random sample consensus), etc. Such mapping can be performed using an algorithm that is known or will be developed later.

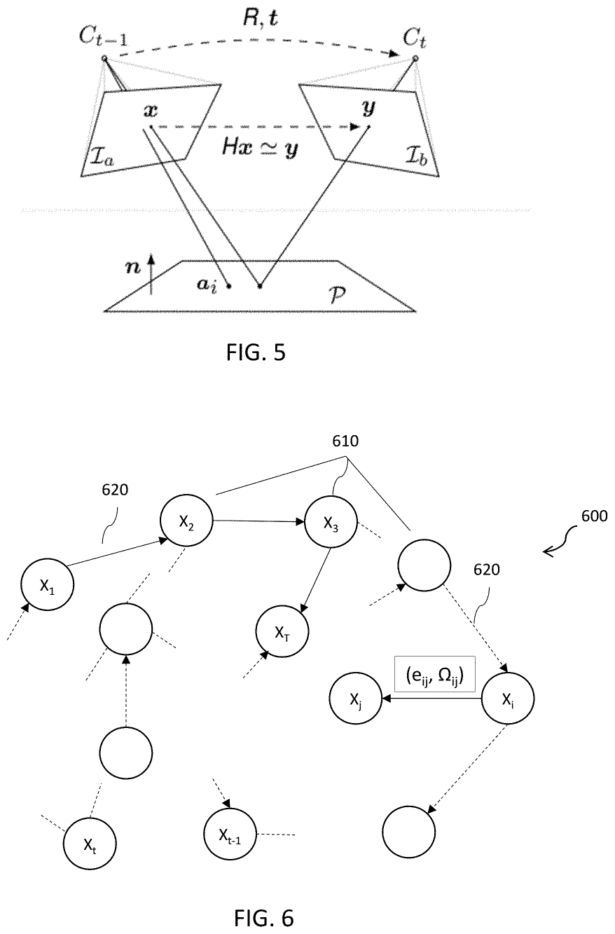

The method 200 further includes matching the planes 410 that are mapped with the LIDAR data with corresponding planes that are mapped in an earlier frame, at block 214. Here, each frame is captured at a particular pose of the scanner 120. The pose can include a position (i.e., coordinates in the environment), and orientation of the scanner 120. FIG. 5 depicts a block diagram of matching planes from one frame with another according to one or more embodiments of the present disclosure. Cₜ₋₁ depicts a first position of the scanner 120 at time t-1, and Cₜ depicts a second position of the scanner 120 as it is moved to scan the environment. From each of these positions, the scanner 120 can observe and capture a plane P. The scanner 120 captures an image Ia at the first position and an image Ib at the second position. Each of these images includes the plane P. Here, plane P can be any one of the several planes that are in the environment. Consider that the plane P has a normal depicted by n.

The scanner 120 moves from the first position to the second position at a predetermined speed, for example, R meters per second. In addition, the scanner 120 is configured to capture successive frames at a predetermined frequency, for example, 10 Hz, 15 Hz, etc. In one or more embodiments of the present invention, the computing system 110 processes the captured frames at a second predetermined frequency, for example, 30 Hz, 45 Hz, etc. For example, during live scanning, i.e., at substantially real-time when the data is being captured, the data is processed using techniques described herein at a lower frequency e.g. 10 Hz. However, the scanner 120 captures and stores data at a higher frequency, e.g., 30 Hz or more. Later, in an offline processing step, the system can process the stored data as well and use all of the data stored to provide more accurate results.

In the example shown in FIG. 5, consider that the plane P has a landmark aᵢ that is captured at a position x in the image Ia from the first position; and further, that the landmark aᵢ is at a position y in the second image Ib that is captured from the second position.

Referring to the flowchart in FIG. 2, matching the planes detected from the first position and those detected from the second position includes determining the common frames from the two positions. In this example scenario of FIG. 5, the plane P is one of such common planes. The method 200 includes determining a constraint for SLAM implementation based on the matching, at block 216.

Once P is determined, the matching further includes determining a relationship between any landmark points that are on that plane, such as aᵢ in this case. The relationship can be a mapping between the point x that represents the landmark from the first position, and the pointy that represents the same landmark from the second position. For example, the computing system 110 determines a mapping such as Hx≈y. Here, H can be a matrix that translates and rotates x, where x and y can be 2D or 3D coordinates. In one or more embodiments of the present disclosure, x and y can be matrices that represent more than one point. H is a relative measurement constraint that can be used by the scanner when implementing the SLAM algorithm.

The method 200 further includes executing the SLAM algorithm, at block 218. The SLAM algorithm can be implemented by the computing system 110, and/or the processor 124. As noted earlier, the SLAM algorithm is used to provide concurrent construction of a model of the environment (the scan), and an estimation of the state of the scanner 120 moving within the environment. In other words, SLAM gives you a way to track the location of a robot in the world in real-time and identify the locations of landmarks such as buildings, trees, rocks, walls, doors, windows, paintings, decor, furniture, and other world features. In addition to localization, SLAM also builds up a model of the environment to locate objects including the landmarks that surround the scanner 120 and so that the scan data can be used to ensure that the scanner 120 is on the right path as the scanner 120 moves through the world, i.e., environment. So, the technical challenge with the implementation of SLAM is that while building the scan, the scanner 120 itself might lose track of where it is by virtue of its motion uncertainty because there is no presence of an existing map of the environment because the map is being generated simultaneously.

The basis for SLAM is to gather information from the set of sensors 120 and motions over time and then use information about measurements and motion to reconstruct a map of the environment. The SLAM algorithm defines the probabilities of the scanner 120 being at a certain location in the environment, i.e., at certain coordinates, using a sequence of constraints. For example, consider that the scanner 120 moves in some environment, the SLAM algorithm is input the initial location of the scanner 120, say (0,0) initially, which is also called as Initial Constraints. The SLAM algorithm is then inputted several relative constraints that relate each pose of the scanner 120 to a previous pose of the scanner 120. Such constraints are also referred to as relative motion constraints.

The technical challenge of SLAM can also be described as follows. Consider that the scanner is moving in an unknown environment, along a trajectory described by the sequence of random variables x_{1:T}={x₁, . . . , x_{T}}. While moving, the scanner acquires a sequence of odometry measurements u_{1:T}={u₁, . . . , u_{T}} and perceptions of the environment z_{1:T}={z₁, . . . , z_{T}}. The “perceptions” include the captured data and the mapped detected planes 410. Solving the full SLAM problem now includes estimating the posterior probability of the trajectory of the scanner 120 x_{1:T} and the map M of the environment given all the measurements plus an initial position x₀: P(x_{1:T}, M|z_{1:T}, u_{1:T}, x₀). The initial position x₀ defines the position in the map and can be chosen arbitrarily. There are several known approaches to implement SLAM, for example, graph SLAM, multi-level relaxation SLAM, sparse matrix-based SLAM, hierarchical SLAM, etc. The technical solutions described herein are applicable regardless of which technique is used to implement SLAM.

FIG. 6 depicts a graphical representation of an example SLAM implementation. In the depicted representation of the SLAM as a graph 600, every node 610 corresponds to a pose of the scanner 120. Nearby poses are connected by edges 620 that model spatial constraints between poses of the scanner 120 arising from measurements. Edges e_{t-1, t} between consecutive poses model odometry measurements, while the other edges represent spatial constraints arising from multiple observations of the same part of the environment.

A graph-based SLAM approach constructs a simplified estimation problem by abstracting the raw sensor measurements. These raw measurements are replaced by the edges 620 in graph 600, which can then be seen as “virtual measurements.” An edge 620 between two nodes 610 are labeled with a probability distribution over the relative locations of the two poses, conditioned to their mutual measurements. In general, the observation model P(zₜ|xₜ, Mₜ) is multi-modal, and therefore the Gaussian assumption does not hold. This means that a single observation zₜ might result in multiple potential edges connecting different poses in the graph, and the graph connectivity needs itself to be described as a probability distribution. Directly dealing with this multi-modality in the estimation process would lead to a combinatorial explosion of complexity. As a result of that, most practical approaches restrict the estimate to the most likely topology. Hence, a constraint resulting from observation has to be determined.

If the observations are affected by (locally) Gaussian noise and the data association is known, the goal of a graph-based mapping algorithm is to compute a Gaussian approximation of the posterior over the trajectory of the scanner 120. This involves computing the mean of this Gaussian as the configuration of the nodes 610 that maximizes the likelihood of the observations. Once the mean is known, the information matrix of the Gaussian can be obtained in a straightforward fashion, as is known in the art. In the following, we will characterize the task of finding this maximum as a constraint optimization problem.

Let x=(x₁, . . . , x_{T})^{T} be a vector of parameters, where xᵢ describes the pose of node i. Let zᵢⱼ and Ωᵢⱼ be respectively the mean and the information matrix of a virtual measurement between the node i and the node j. This virtual measurement is a transformation that makes the observations acquired from i maximally overlap with the observation acquired from j. Further, let \hat{z}_{y}(xᵢ, xⱼ) be the prediction of a virtual measurement given a configuration of the nodes xᵢ, and xⱼ. Usually, this prediction is the relative transformation between the two nodes. Let e(xᵢ, xⱼ, zᵢⱼ) be a function that computes a difference between the expected observation \hat{z}ᵢⱼ and the real observation zᵢⱼ captured by the scanner 120. For simplicity of notation, the indices of the measurement are encoded in the indices of the error function: eᵢⱼ(xᵢ, xⱼ)=zᵢⱼ−\hat{z}ᵢⱼⱼ(xᵢ, xⱼ).

If C is the set of pairs of indices for which a constraint (observation) z exists, the goal of a maximum likelihood approach is to find the configuration of the nodes x* that minimizes the negative log-likelihood F(x) of all the observations: F(x)=Σ_{(i,j)∈C}Fᵢⱼ, where Fᵢⱼ=eᵢⱼ^{T}Ωᵢⱼeᵢⱼ. Accordingly, implementing SLAM includes solving the following equation and computing a Gaussian approximation of the posterior over the trajectory of the scanner 120:x*=argminₓF(x).

Several techniques are known for solving the above equations, for example, using Gauss-Newton or the Levenberg-Marquardt algorithms. The technical solutions provided by one or more embodiments of the present invention can be used regardless of how the SLAM algorithm is implemented, i.e., regardless of how the above equations are solved. The technical solutions described herein provide the set of constraints C that is used for implementing the SLAM algorithm, using whichever technique is to be used.

As an example, consider the use of a landmark that can be seen by the scanner 120 from various locations, which would be Relative Measurement Constraints every time the scanner sees a landmark. So, SLAM can use those constraints in order to find the most likely configuration of the scanner path along with the location of landmarks.

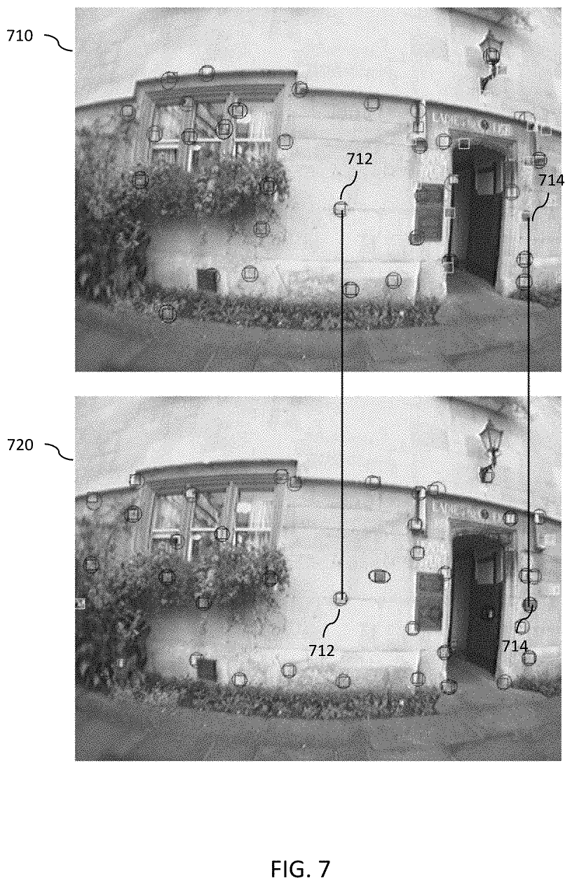

FIG. 7 depicts a real-world example scenario implementing the technical features provided by one or more embodiments of the present invention. In FIG. 7, each of the views 710 and 720 depicts image data captured by the camera with LIDAR data projected on the image. The first view 710 is captured from a first position, and the second view 720 is captured from a second position. Two landmarks, 712 and 714 are depicted, both of which are captured in the two views 710 and 720.

It should be noted that in the images shown in FIG. 7, the lines are curved because the images are captured by a wide field-of-view camera 122B.

Referring back to FIG. 2, the method 200 further includes performing a loop closure using the detected planes, at block 220. Typically, natural features, i.e., landmarks (e.g. edges, corners), are used for performing loop closure. Loop closure is performed to check if the scanner has already been at a certain position, and if so, determine an error in measurement compared to a baseline measurement from that position. The error is caused by drift. The error is compensated for by reconfiguring the scanner 120 to achieve the baseline measurement, and in addition, to adjust the measurements captured by the scanner 120 during the loop. Here, a “loop” is the path taken by the scanner 120 from the particular position back to the same particular position.

In one or more embodiments of the present disclosure, a plane that has been identified and detected multiple times can be used to perform such loop closure together with natural features. A plane 410 that is detected is assigned a unique identifier to mark the plane as a virtual landmark to be used for loop closure. Several factors of plane 410 can be stored for performing the loop closure. For example, the factors include dimensions, such as length, breadth, distance from scanner 120, and plane-normal. An initial set of factors is stored as baseline measurements for plane 410. When the plane 410 is detected from another position, or from substantially the same position after completing a loop, the scanner 120 can determine a second set of the factors. The second set of factors is compared with the baseline to determine the error(s). The error(s) are then used to adjust the data-captured by the scanner 120 since the baseline measurements to compensate for the error(s).

In addition to improving the SLAM implementation, the technical features provided by one or more embodiments of the present disclosure facilitate using plane information to improve the matching of submaps generated during the implementation of SLAM. For example, the planes are turned into point clouds based on the plane information and the contours detected in the captured images. A technical challenge with implementing the SLAM is that matching with lines in 3D does not work reliably. Once the submaps are assembled using the matched lines, the mapping is not changed anymore, and errors in the submaps can continue to accumulate and cause greater errors.

In one or more embodiments of the present disclosure, the point cloud generated from the plane may be removed after a successful match or may even be used to densify data.

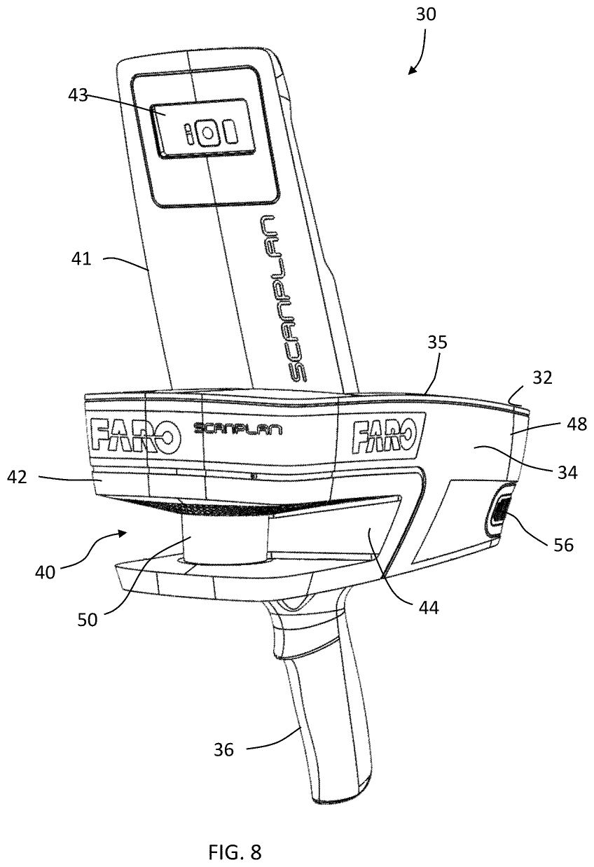

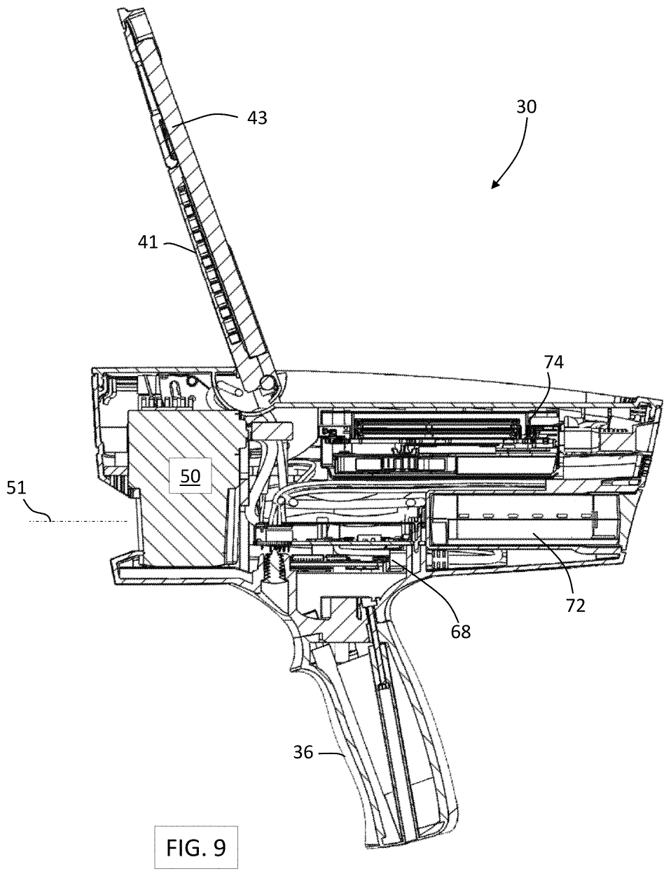

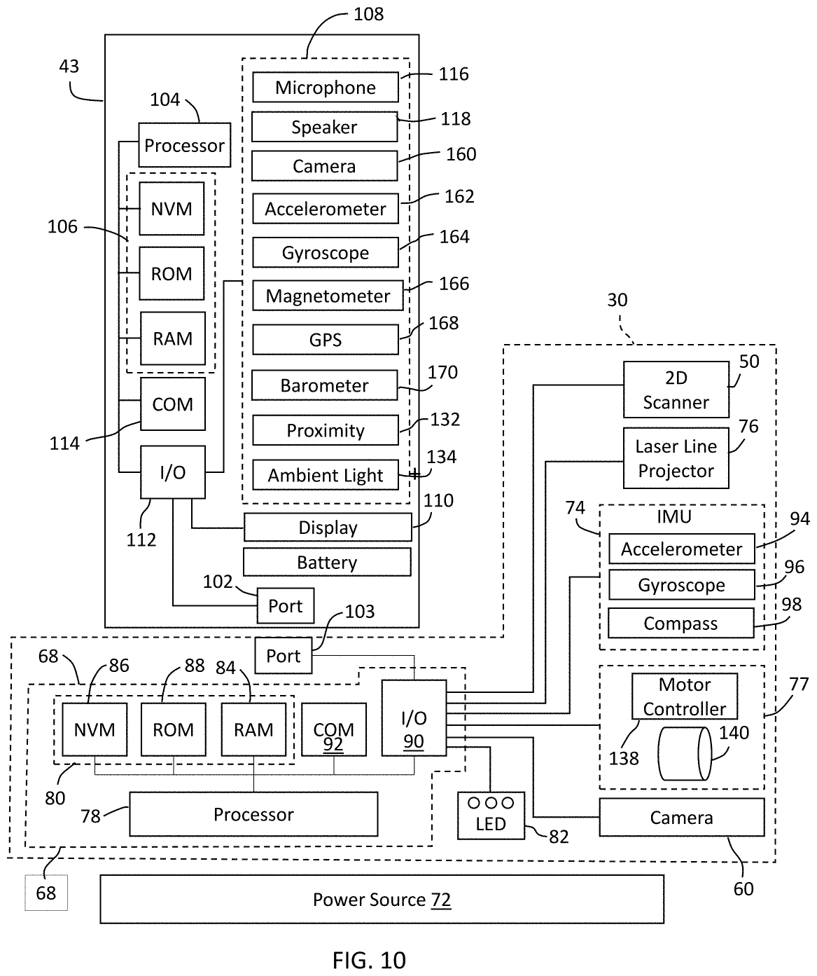

FIG. 8, FIG. 9, and FIG. 10 depict an embodiment of a system 30 having a housing 32 that includes a body portion 34 and a handle portion 36. The system 30 can be used as the scanner 120. In an embodiment, the handle 36 may include an actuator 38 that allows the operator to interact with the system 30. In the exemplary embodiment, the body 34 includes a generally rectangular center portion 35 with a slot 40 formed in an end 42. The slot 40 is at least partially defined by a pair walls 44 that are angled towards a second end 48. As will be discussed in more detail herein, a portion of a two-dimensional scanner 50 is arranged between the walls 44. The walls 44 are angled to allow the scanner 50 to operate by emitting a light over a large angular area without interference from the walls 44. As will be discussed in more detail herein, the end 42 may further include a three-dimensional camera or RGBD camera 60.

Extending from the center portion 35 is a mobile device holder 41. The mobile device holder 41 is configured to securely couple a mobile device 43 to the housing 32. The holder 41 may include one or more fastening elements, such as a magnetic or mechanical latching element for example, that couples the mobile device 43 to the housing 32. In an embodiment, the mobile device 43 is coupled to communicate with a controller 68. The communication between the controller 68 and the mobile device 43 may be via any suitable communications medium, such as wired, wireless or optical communication mediums for example.

In the illustrated embodiment, the holder 41 is pivotally coupled to the housing 32, such that it may be selectively rotated into a closed position within a recess 46. In an embodiment, the recess 46 is sized and shaped to receive the holder 41 with the mobile device 43 disposed therein.

In the exemplary embodiment, the second end 48 includes a plurality of exhaust vent openings 56. In an embodiment the exhaust vent openings 56 are fluidly coupled to intake vent openings 58 arranged on a bottom surface 62 of center portion 35. The intake vent openings 58 allow external air to enter a conduit 64 having an opposite opening 66 in fluid communication with the hollow interior 67 of the body 34. In an embodiment, the opening 66 is arranged adjacent to a controller 68 which has one or more processors that is operable to perform the methods described herein. In an embodiment, the external air flows from the opening 66 over or around the controller 68 and out the exhaust vent openings 56.

The controller 68 is coupled to a wall 70 of body 34. In an embodiment, the wall 70 is coupled to or integral with the handle 36. The controller 68 is electrically coupled to the 2D scanner 50, the 3D camera 60, a power source 72, an inertial measurement unit (IMU) 74, a laser line projector 76, and a haptic feedback device 77.

Elements are shown of the system 30 with the mobile device 43 installed or coupled to the housing 32. Controller 68 is a suitable electronic device capable of accepting data and instructions, executing the instructions to process the data, and presenting the results. The controller 68 includes one or more processing elements 78. The processors may be microprocessors, field programmable gate arrays (FPGAs), digital signal processors (DSPs), and generally any device capable of performing computing functions. The one or more processors 78 have access to memory 80 for storing information.

Controller 68 can convert the analog voltage or current level provided by 2D scanner 50, camera 60 and IMU 74 into a digital signal to determine a distance from the system 30 to an object in the environment. In an embodiment, the camera 60 is a 3D or RGBD type camera. Controller 68 uses the digital signals that act as input to various processes for controlling the system 30. The digital signals represent one or more system 30 data including but not limited to distance to an object, images of the environment, acceleration, pitch orientation, yaw orientation and roll orientation. As will be discussed in more detail, the digital signals may be from components internal to the housing 32 or from sensors and devices located in the mobile device 43.

In general, when the mobile device 43 is not installed, controller 68 accepts data from 2D scanner 50 and IMU 74 and is given certain instructions for the purpose of generating a two-dimensional map of a scanned environment. Controller 68 provides operating signals to the 2D scanner 50, the camera 60, laser line projector 76 and haptic feedback device 77. Controller 68 also accepts data from IMU 74, indicating, for example, whether the operator is operating in the system in the desired orientation. The controller 68 compares the operational parameters to predetermined variances (e.g. yaw, pitch or roll thresholds) and if the predetermined variance is exceeded, generates a signal that activates the haptic feedback device 77. The data received by the controller 68 may be displayed on a user interface coupled to controller 68. The user interface may be one or more LEDs (light-emitting diodes) 82, an LCD (liquid-crystal diode) display, a CRT (cathode ray tube) display, or the like. A keypad may also be coupled to the user interface for providing data input to controller 68. In one embodiment, the user interface is arranged or executed on the mobile device 43.

The controller 68 may also be coupled to external computer networks such as a local area network (LAN) and the Internet. A LAN interconnects one or more remote computers, which are configured to communicate with controller 68 using a well-known computer communications protocol such as TCP/IP (Transmission Control Protocol/Internet Protocol), RS-232, ModBus, and the like. Additional systems 30 may also be connected to LAN with the controllers 68 in each of these systems 30 being configured to send and receive data to and from remote computers and other systems 30. The LAN may be connected to the Internet. This connection allows controller 68 to communicate with one or more remote computers connected to the Internet.

The processors 78 are coupled to memory 80. The memory 80 may include random access memory (RAM) device 84, a non-volatile memory (NVM) device 86, a read-only memory (ROM) device 88. In addition, the processors 78 may be connected to one or more input/output (I/O) controllers 90 and a communications circuit 92. In an embodiment, the communications circuit 92 provides an interface that allows wireless or wired communication with one or more external devices or networks, such as the LAN discussed above.

Controller 68 includes operation control methods described herein, which can be embodied in application code. These methods are embodied in computer instructions written to be executed by processors 78, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (Hypertext Markup Language), Python, Ruby and any combination or derivative of at least one of the foregoing.

Coupled to the controller 68 is the 2D scanner 50. The 2D scanner 50 measures 2D coordinates in a plane. In the exemplary embodiment, the scanning is performed by steering light within a plane to illuminate object points in the environment. The 2D scanner 50 collects the reflected (scattered) light from the object points to determine 2D coordinates of the object points in the 2D plane. In an embodiment, the 2D scanner 50 scans a spot of light over an angle while at the same time measuring an angle value and corresponding distance value to each of the illuminated object points.

Examples of 2D scanners 50 include but are not limited to Model LMS103 scanners manufactured by Sick, Inc of Minneapolis, Minn. and scanner Models URG-04LX-UG01 and UTM-30LX manufactured by Hokuyo Automatic Co., Ltd of Osaka, Japan. The scanners in the Sick LMS103 family measure angles over a 270-degree range and over distances up to 20 meters. The Hoyuko model URG-04LX-UG01 is a low-cost 2D scanner that measures angles over a 240-degree range and distances up to 4 meters. The Hoyuko model UTM-30LX is a 2D scanner that measures angles over a 270-degree range and to distances up to 30 meters. It should be appreciated that the above 2D scanners are exemplary and other types of 2D scanners are also available.

In an embodiment, the 2D scanner 50 is oriented so as to scan a beam of light over a range of angles in a generally horizontal plane (relative to the floor of the environment being scanned). At instants in time the 2D scanner 50 returns an angle reading and a corresponding distance reading to provide 2D coordinates of object points in the horizontal plane. In completing one scan over the full range of angles, the 2D scanner returns a collection of paired angle and distance readings. As the system 30 is moved from place to place, the 2D scanner 50 continues to return 2D coordinate values. These 2D coordinate values are used to locate the position of the system 30 thereby enabling the generation of a two-dimensional map or floorplan of the environment.

Also coupled to the controller 68 is the IMU 74. The IMU 74 is a position/orientation sensor that may include accelerometers 94 (inclinometers), gyroscopes 96, a magnetometer or compass 98, and altimeters. In the exemplary embodiment, the IMU 74 includes multiple accelerometers 94 and gyroscopes 96. The compass 98 indicates a heading based on changes in magnetic field direction relative to the earth's magnetic north. The IMU 74 may further have an altimeter that indicates altitude (height). An example of a widely used altimeter is a pressure sensor. By combining readings from a combination of position/orientation sensors with a fusion algorithm that may include a Kalman filter, relatively accurate position and orientation measurements can be obtained using relatively low-cost sensor devices. In the exemplary embodiment, the IMU 74 determines the pose or orientation of the system 30 about three-axis to allow a determination of a yaw, roll and pitch parameter.

The system 30 further includes a camera 60 that is a 3D or RGB-D camera. As used herein, the term 3D camera refers to a device that produces a two-dimensional image that includes distances to a point in the environment from the location of system 30. The 3D camera 30 may be a range camera or a stereo camera. In an embodiment, the 3D camera 30 includes an RGB-D sensor that combines color information with a per-pixel depth information. In an embodiment, the 3D camera 30 may include an infrared laser projector 31, a left infrared camera 33, a right infrared camera 39, and a color camera 37. In an embodiment, the 3D camera 60 is a RealSense™ camera model R200 manufactured by Intel Corporation. In still another embodiment, the 3D camera 30 is a RealSense™ LIDAR camera model L515 manufactured by Intel Corporation.

In an embodiment, when the mobile device 43 is coupled to the housing 32, the mobile device 43 becomes an integral part of the system 30. In an embodiment, the mobile device 43 is a cellular phone, a tablet computer or a personal digital assistant (PDA). The mobile device 43 may be coupled for communication via a wired connection, such as ports 103, 102. The port 103 is coupled for communication to the processor 78, such as via I/O controller 90 for example. The ports 103, 102 may be any suitable port, such as but not limited to USB, USB-A, USB-B, USB-C, IEEE 1394 (Firewire), or Lightning™ connectors.

The mobile device 43 is a suitable electronic device capable of accepting data and instructions, executing the instructions to process the data, and presenting the results. The mobile device 43 includes one or more processing elements 104. The processors may be microprocessors, field programmable gate arrays (FPGAs), digital signal processors (DSPs), and generally any device capable of performing computing functions. The one or more processors 104 have access to memory 106 for storing information.

The mobile device 43 can convert the analog voltage or current level provided by sensors 108 and processor 78. Mobile device 43 uses the digital signals that act as input to various processes for controlling the system 30. The digital signals represent one or more system 30 data including but not limited to distance to an object, images of the environment, acceleration, pitch orientation, yaw orientation, roll orientation, global position, ambient light levels, and altitude for example.

In general, mobile device 43 accepts data from sensors 108 and is given certain instructions for the purpose of generating or assisting the processor 78 in the generation of a two-dimensional map or three-dimensional map of a scanned environment. Mobile device 43 provides operating signals to the processor 78, the sensors 108 and a display 110. Mobile device 43 also accepts data from sensors 108, indicating, for example, to track the position of the mobile device 43 in the environment or measure coordinates of points on surfaces in the environment. The mobile device 43 compares the operational parameters to predetermined variances (e.g. yaw, pitch or roll thresholds) and if the predetermined variance is exceeded, may generate a signal. The data received by the mobile device 43 may be displayed on display 110. In an embodiment, the display 110 is a touch screen device that allows the operator to input data or control the operation of the system 30.

The controller 68 may also be coupled to external networks such as a local area network (LAN), a cellular network and the Internet. A LAN interconnects one or more remote computers, which are configured to communicate with controller 68 using a well-known computer communications protocol such as TCP/IP (Transmission Control Protocol/Internet Protocol), RS-232, ModBus, and the like. Additional systems 30 may also be connected to LAN with the controllers 68 in each of these systems 30 being configured to send and receive data to and from remote computers and other systems 30. The LAN may be connected to the Internet. This connection allows controller 68 to communicate with one or more remote computers connected to the Internet.

The processors 104 are coupled to memory 106. The memory 106 may include random access memory (RAM) device, a non-volatile memory (NVM) device, and a read-only memory (ROM) device. In addition, the processors 104 may be connected to one or more input/output (I/O) controllers 112 and a communications circuit 114. In an embodiment, the communications circuit 114 provides an interface that allows wireless or wired communication with one or more external devices or networks, such as the LAN or the cellular network discussed above.

Processor 104 includes operation control methods described herein, which can be embodied in application code. These methods are embodied in computer instructions written to be executed by processors 78, 104, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (Hypertext Markup Language), Python, Ruby and any combination or derivative of at least one of the foregoing.

Also coupled to the processor 104 are the sensors 108. The sensors 108 may include but are not limited to: a microphone 116; a speaker 118; a front or rear facing camera 160; accelerometers 162 (inclinometers), gyroscopes 164, a magnetometers or compass 126; a global positioning satellite (GPS) module 168; a barometer 170; a proximity sensor 132; and an ambient light sensor 134. By combining readings from a combination of sensors 108 with a fusion algorithm that may include a Kalman filter, relatively accurate position and orientation measurements can be obtained.

It should be appreciated that the sensors 60, 74 integrated into the scanner 30 may have different characteristics than the sensors 108 of mobile device 43. For example, the resolution of the cameras 60, 160 may be different, or the accelerometers 94, 162 may have different dynamic ranges, frequency response, sensitivity (mV/g) or temperature parameters (sensitivity or range). Similarly, the gyroscopes 96, 164 or compass/magnetometer may have different characteristics. It is anticipated that in some embodiments, one or more sensors 108 in the mobile device 43 may be of higher accuracy than the corresponding sensors 74 in the system 30. As described in more detail herein, in some embodiments the processor 78 determines the characteristics of each of the sensors 108 and compares them with the corresponding sensors in the system 30 when the mobile device. The processor 78 then selects which sensors 74, 108 are used during operation. In some embodiments, the mobile device 43 may have additional sensors (e.g. microphone 116, camera 160) that may be used to enhance operation compared to operation of the system 30 without the mobile device 43. In still further embodiments, the system 30 does not include the IMU 74 and the processor 78 uses the sensors 108 for tracking the position and orientation/pose of the system 30. In still further embodiments, the addition of the mobile device 43 allows the system 30 to utilize the camera 160 to perform three-dimensional (3D) measurements either directly (using an RGB-D camera) or using photogrammetry techniques to generate 3D maps. In an embodiment, the processor 78 uses the communications circuit (e.g. a cellular 4G internet connection) to transmit and receive data from remote computers or devices.

In the exemplary embodiment, the system 30 is a handheld portable device that is sized and weighted to be carried by a single person during operation. Therefore, the plane 136 in which the 2D scanner 50 projects a light beam may not be horizontal relative to the floor or may continuously change as the computer moves during the scanning process. Thus, the signals generated by the accelerometers 94, gyroscopes 96 and compass 98 (or the corresponding sensors 108) may be used to determine the pose (yaw, roll, tilt) of the system 30 and determine the orientation of the plane 51.

In an embodiment, it may be desired to maintain the pose of the system 30 (and thus the plane 136) within predetermined thresholds relative to the yaw, roll and pitch orientations of the system 30. In an embodiment, a haptic feedback device 77 is disposed within the housing 32, such as in the handle 36. The haptic feedback device 77 is a device that creates a force, vibration or motion that is felt or heard by the operator. The haptic feedback device 77 may be, but is not limited to: an eccentric rotating mass vibration motor or a linear resonant actuator for example. The haptic feedback device is used to alert the operator that the orientation of the light beam from 2D scanner 50 is equal to or beyond a predetermined threshold. In operation, when the IMU 74 measures an angle (yaw, roll, pitch or a combination thereof), the controller 68 transmits a signal to a motor controller 138 that activates a vibration motor 140. Since the vibration originates in the handle 36, the operator will be notified of the deviation in the orientation of the system 30. The vibration continues until the system 30 is oriented within the predetermined threshold or the operator releases the actuator 38. In an embodiment, it is desired for the plane 136 to be within 10-15 degrees of horizontal (relative to the ground) about the yaw, roll and pitch axes.

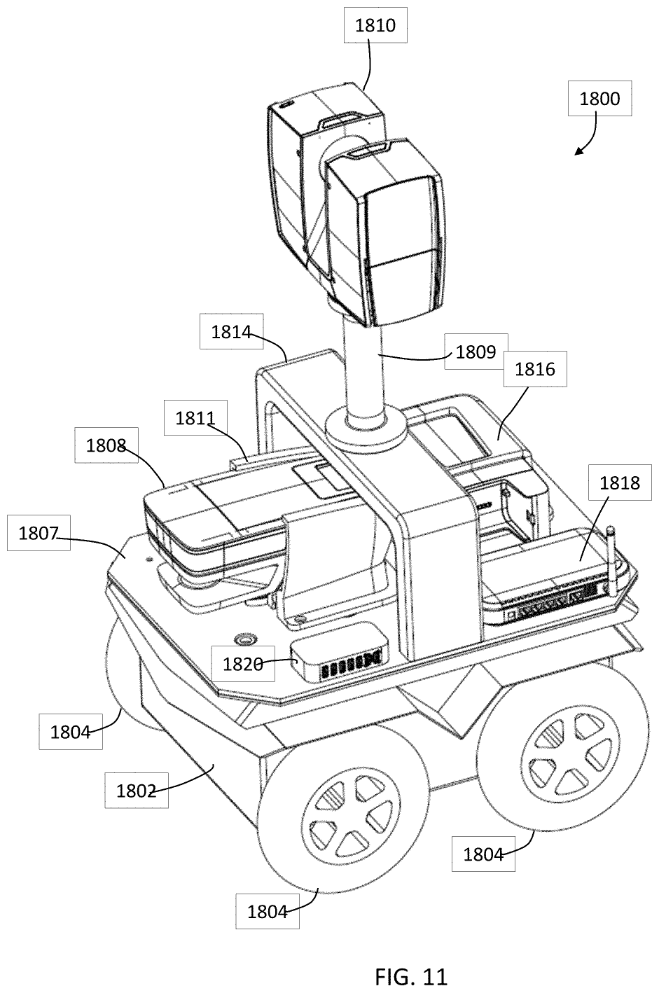

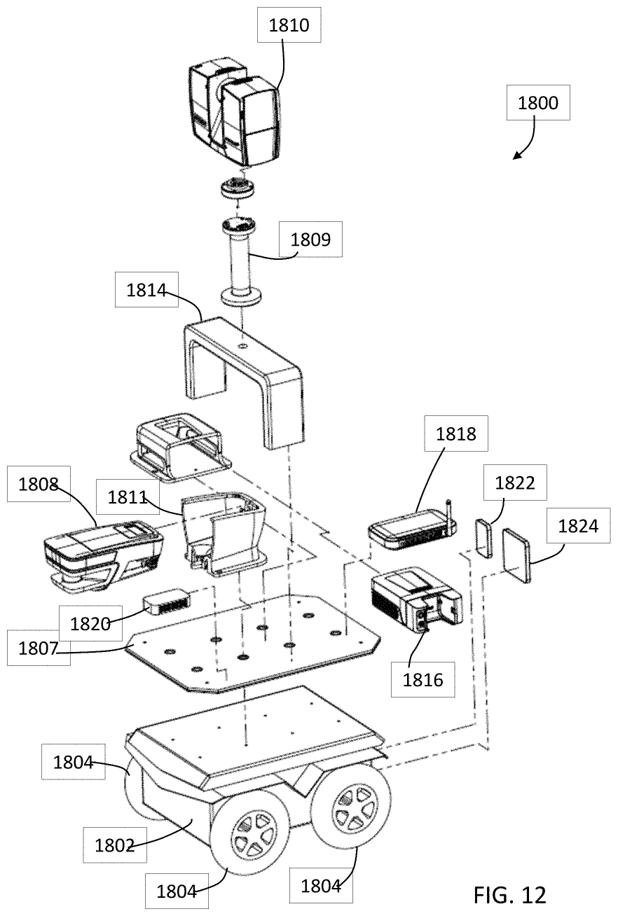

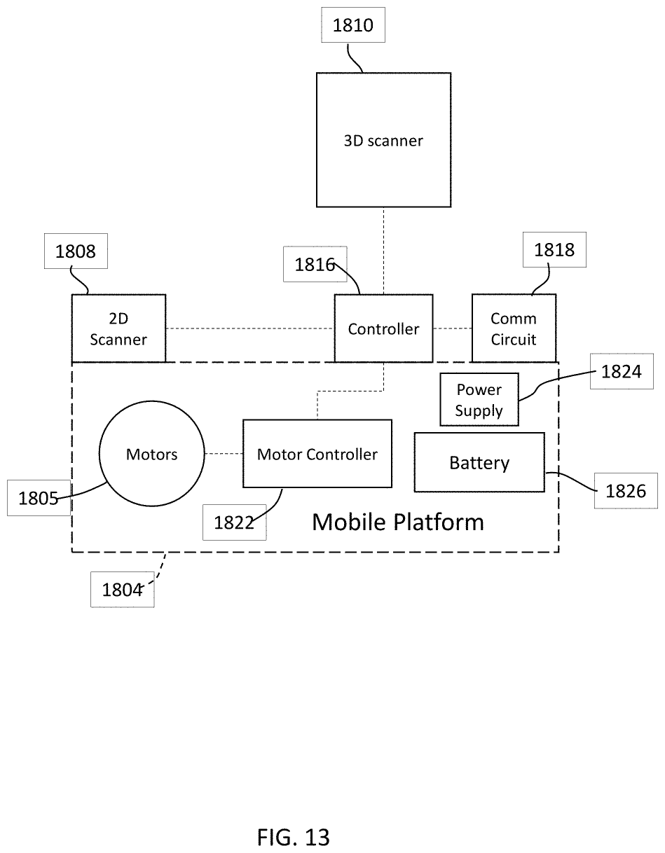

Referring now to FIG. 11, FIG.12, and FIG. 13, an embodiment is shown of a mobile scanning platform 1800. The mobile scanning platform 1800 can be used as the scanner 120. The mobile scanning platform 1800 includes a base unit 1802 having a plurality of wheels 1804. The wheels 1804 are rotated by motors 1805. In an embodiment, an adapter plate 1807 is coupled to the base unit 1802 to allow components and modules to be coupled to the base unit 1802. The mobile scanning platform 1800 further includes a 2D scanner 1808 and a 3D scanner 1810. In the illustrated embodiment, each scanner 1808, 1810 is removably coupled to the adapter plate 1806. The 2D scanner 1808 may be the scanner illustrated and described herein. As will be described in more detail herein, in some embodiments the 2D scanner 1808 is removable from the adapter plate 1806 and is used to generate a map of the environment, plan a path for the mobile scanning platform to follow, and define 3D scanning locations. In the illustrated embodiment, the 2D scanner 1808 is slidably coupled to a bracket 1811 that couples the 2D scanner 1808 to the adapter plate 1807.

In an embodiment, the 3D scanner 1810 is a time-of-flight (TOF) laser scanner such as that shown and described herein. The scanner 1810 may be that described in commonly owned U.S. Pat. No. 8,705,012, which is incorporated by reference herein. In an embodiment, the 3D scanner 1810 mounted on a pedestal or post 1809 that elevates the 3D scanner 1810 above (e.g. further from the floor than) the other components in the mobile scanning platform 1800 so that the emission and receipt of the light beam is not interfered with. In the illustrated embodiment, the pedestal 1809 is coupled to the adapter plate 1807 by a u-shaped frame 1814.

In an embodiment, the mobile scanning platform 1800 further includes a controller 1816. The controller 1816 is a computing device having one or more processors and memory. The one or more processors are responsive to non-transitory executable computer instructions for performing operational methods such as those described herein. The processors may be microprocessors, field programmable gate arrays (FPGAs), digital signal processors (DSPs), and generally any device capable of performing computing functions. The one or more processors have access to memory for storing information.

Coupled for communication to the controller 1816 is a communications circuit 1818 and an input/output hub 1820. In the illustrated embodiment, the communications circuit 1818 is configured to transmit and receive data via a wireless radio-frequency communications medium, such as WIFI or Bluetooth for example. In an embodiment, the 2D scanner 1808 communicates with the controller 1816 via the communications circuit 1818

In an embodiment, the mobile scanning platform 1800 further includes a motor controller 1822 that is operably coupled to the control the motors 1805. In an embodiment, the motor controller 1822 is mounted to an external surface of the base unit 1802. In another embodiment, the motor controller 1822 is arranged internally within the base unit 1802. The mobile scanning platform 1800 further includes a power supply 1824 that controls the flow of electrical power from a power source, such as batteries 1826 for example. The batteries 1826 may be disposed within the interior of the base unit 1802. In an embodiment, the base unit 1802 includes a port (not shown) for coupling the power supply to an external power source for recharging the batteries 1826. In another embodiment, the batteries 1826 are removable or replaceable.

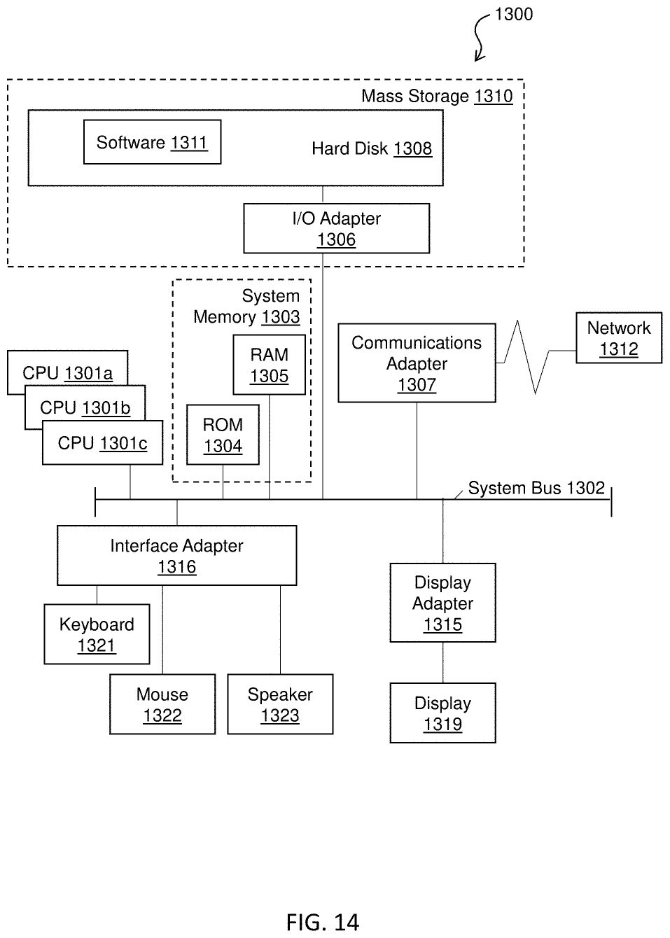

Turning now to FIG. 14, a computer system 1300 is generally shown in accordance with an embodiment. The computer system 1300 can be an electronic, computer framework comprising and/or employing any number and combination of computing devices and networks utilizing various communication technologies, as described herein. The computer system 1300 can be easily scalable, extensible, and modular, with the ability to change to different services or reconfigure some features independently of others. The computer system 1300 may be, for example, a server, desktop computer, laptop computer, tablet computer, or smartphone. In some examples, computer system 1300 may be a cloud computing node. Computer system 1300 may be described in the general context of computer system executable instructions, such as program modules, being executed by a computer system. Generally, program modules may include routines, programs, objects, components, logic, data structures, and so on that perform particular tasks or implement particular abstract data types. Computer system 1300 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 14, the computer system 1300 has one or more central processing units (CPU(s)) 1301a, 1301b, 1301c, etc. (collectively or generically referred to as processor(s) 1301). The processors 1301 can be a single-core processor, multi-core processor, computing cluster, or any number of other configurations. The processors 1301, also referred to as processing circuits, are coupled via a system bus 1302 to a system memory 1303 and various other components. The system memory 1303 can include a read only memory (ROM) 1304 and a random access memory (RAM) 1305. The ROM 1304 is coupled to the system bus 1302 and may include a basic input/output system (BIOS), which controls certain basic functions of the computer system 1300. The RAM is read-write memory coupled to the system bus 1302 for use by the processors 1301. The system memory 1303 provides temporary memory space for operations of said instructions during operation. The system memory 1303 can include random access memory (RAM), read only memory, flash memory, or any other suitable memory systems.

The computer system 1300 comprises an input/output (I/O) adapter 1306 and a communications adapter 1307 coupled to the system bus 1302. The I/O adapter 1306 may be a small computer system interface (SCSI) adapter that communicates with a hard disk 1308 and/or any other similar component. The I/O adapter 1306 and the hard disk 1308 are collectively referred to herein as a mass storage 1310.

Software 1311 for execution on the computer system 1300 may be stored in the mass storage 1310. The mass storage 1310 is an example of a tangible storage medium readable by the processors 1301, where the software 1311 is stored as instructions for execution by the processors 1301 to cause the computer system 1300 to operate, such as is described herein below with respect to the various Figures. Examples of computer program product and the execution of such instruction is discussed herein in more detail. The communications adapter 1307 interconnects the system bus 1302 with a network 1312, which may be an outside network, enabling the computer system 1300 to communicate with other such systems. In one embodiment, a portion of the system memory 1303 and the mass storage 1310 collectively store an operating system, which may be any appropriate operating system, such as the z/OS or AIX operating system from IBM Corporation, to coordinate the functions of the various components shown in FIG. 14.

Additional input/output devices are shown as connected to the system bus 1302 via a display adapter 1315 and an interface adapter 1316 and. In one embodiment, the adapters 1306, 1307, 1315, and 1316 may be connected to one or more I/O buses that are connected to the system bus 1302 via an intermediate bus bridge (not shown). A display 1319 (e.g., a screen or a display monitor) is connected to the system bus 1302 by a display adapter 1315, which may include a graphics controller to improve the performance of graphics intensive applications and a video controller. A keyboard 1321, a mouse 1322, a speaker 1323, etc. can be interconnected to the system bus 1302 via the interface adapter 1316, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 14, the computer system 1300 includes processing capability in the form of the processors 1301, and, storage capability including the system memory 1303 and the mass storage 1310, input means such as the keyboard 1321 and the mouse 1322, and output capability including the speaker 1323 and the display 1319.

In some embodiments, the communications adapter 1307 can transmit data using any suitable interface or protocol, such as the internet small computer system interface, among others. The network 1312 may be a cellular network, a radio network, a wide area network (WAN), a local area network (LAN), or the Internet, among others. An external computing device may connect to the computer system 1300 through the network 1312. In some examples, an external computing device may be an external webserver or a cloud computing node.

It is to be understood that the block diagram of FIG. 14 is not intended to indicate that the computer system 1300 is to include all of the components shown in FIG. 14. Rather, the computer system 1300 can include any appropriate fewer or additional components not illustrated in FIG. 14 (e.g., additional memory components, embedded controllers, modules, additional network interfaces, etc.). Further, the embodiments described herein with respect to computer system 1300 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

It should be appreciated that while embodiments herein describe supporting the registration of landmarks in a 3D point cloud generated by a phase-shift TOF laser scanner, this is, for example, purposes and the claims should not be so limited. In other embodiments, the 3D coordinate data or point cloud may be generated by any type of 3D measurement device, such as but not limited to a pulsed TOF laser scanner, frequency modulated continuous wave (FMCW) scanner, triangulation scanner, an area scanner, a structured light scanner, a laser line probe, a laser tracker, or a combination of the foregoing. Further, it should be appreciated that the examples described herein show top views of scan data; however, side views can also be used for registration, and such registration can also be improved as described herein.

It should be appreciated that while 3D coordinate data may be used for training, the methods described herein for verifying the registration of landmarks may be used with either two-dimensional or three-dimensional data sets.

Technical effects and benefits of the disclosed embodiments include, but are not limited to, increasing scan quality and a visual appearance of scans acquired by the 3D coordinate measurement device.

It will be appreciated that aspects of the present invention may be embodied as a system, method, or computer program product and may take the form of a hardware embodiment, a software embodiment (including firmware, resident software, micro-code, etc.), or a combination thereof. Furthermore, aspects of the present invention may take the form of a computer program product embodied in one or more computer-readable medium(s) having computer-readable program code embodied thereon.

One or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer-readable storage medium may be a tangible medium containing or storing a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof A computer-readable signal medium may be any computer-readable medium that is not a computer-readable storage medium, and that can communicate, propagate, or transport a program for use by or in connection with an instruction execution system, apparatus, or device.

The computer-readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Terms such as processor, controller, computer, DSP, FPGA are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A system comprising:
an image capture device;
a light detection and ranging (LIDAR) device; and
one or more processors operably coupled to the image capture device and the LIDAR device, wherein the one or more processors are operable to:
capture a first scan-data of the surrounding environment from a first position, and capture a second scan-data of the surrounding environment from a second position, wherein the first scan-data comprises a first image from the image capture device and a first distance-data from the LIDAR device, and the second scan-data comprises a second image from the image capture device and a second distance-data from the LIDAR device;
detect a first set of planes in the first scan-data by projecting the first distance-data on the first image;
detect a second set of planes in the second scan-data by projecting the second distance-data on the second image;
identify a plane that is in the first set of planes and the second set of planes by matching the first set of planes and the second set of planes;
determine a first set of measurements of a landmark on the plane, the first set of measurements determined from the first scan-data;
determine a second set of measurements of said landmark on said plane, the second set of measurements determined from the second scan-data;
determine a constraint by computing a relationship between the first set of measurements and the second set of measurements; and
perform a simultaneous location and mapping by using the constraint.

2. The system of claim 1, the one or more processors are operable to assign a unique identifier to the plane.

3. The system of claim 1, the one or more processors are operable to perform a loop closure using the plane as part of a set of planes.

4. The system of claim 3, wherein performing the loop closure comprises:
determining an error based on the first set of measurements and the second set of measurements;
adjusting a third scan-data based on the error.

5. The system of claim 1, wherein the system captures scan-data at a predetermined frequency.

6. The system of claim 5, wherein the system is moved through the surrounding at a predetermined speed.

7. The system of claim 1, wherein the plane is identified automatically.

8. A method for performing a simultaneous location and mapping using data fusion, the method comprising:
capturing a first scan-data of the surrounding environment from a first position, and capture a second scan-data of the surrounding environment from a second position, wherein the first scan-data comprises a first image from an image capture device and a first distance-data from a LIDAR device, and the second scan-data comprises a second image from the image capture device and a second distance-data from the LIDAR device;
detecting a first set of planes in the first scan-data by projecting the first distance-data on the first image;
detecting a second set of planes in the second scan-data by projecting the second distance-data on the second image;
identifying a plane that is in the first set of planes and the second set of planes by matching the first set of planes and the second set of planes;
determining a first set of measurements of a landmark on the plane, the first set of measurements determined from the first scan-data;
determining a second set of measurements of said landmark on said plane, the second set of measurements determined from the second scan-data;
determining a constraint by computing a relationship between the first set of measurements and the second set of measurements; and
performing the simultaneous location and mapping by using the constraint.

9. The method of claim 8, the one or more processors are operable to assign a unique identifier to the plane.

10. The method of claim 8, the one or more processors are operable to perform a loop closure using the plane as part of a set of planes.

11. The method of claim 10, wherein performing the loop closure comprises:
determining an error based on the first set of measurements and the second set of measurements;
adjusting a third scan-data based on the error.

12. The method of claim 8, wherein the system captures scan-data at a predetermined frequency.

13. The method of claim 12, wherein the system is moved through the surrounding at a predetermined speed.

14. The method of claim 8, wherein the plane is identified automatically.

15. A non-transitory computer-readable medium having program instructions embodied therewith, the program instructions readable by a processor to cause the processor to perform a method for performing a simultaneous location and mapping using data fusion, the method comprising:
capturing a first scan-data of the surrounding environment from a first position, and capture a second scan-data of the surrounding environment from a second position, wherein the first scan-data comprises a first image from an image capture device and a first distance-data from a LIDAR device, and the second scan-data comprises a second image from the image capture device and a second distance-data from the LIDAR device;
detecting a first set of planes in the first scan-data by projecting the first distance-data on the first image;
detecting a second set of planes in the second scan-data by projecting the second distance-data on the second image;
identifying a plane that is in the first set of planes and the second set of planes by matching the first set of planes and the second set of planes;
determining a first set of measurements of a landmark on the plane, the first set of measurements determined from the first scan-data;
determining a second set of measurements of said landmark on said plane, the second set of measurements determined from the second scan-data;
determining a constraint by computing a relationship between the first set of measurements and the second set of measurements; and
performing the simultaneous location and mapping by using the constraint.

16. The computer-readable medium of claim 15, the one or more processors are operable to assign a unique identifier to the plane.

17. The computer-readable medium of claim 15, the one or more processors are operable to perform a loop closure using the plane as part of a set of planes.

18. The computer-readable medium of claim 17, wherein performing the loop closure comprises:
determining an error based on the first set of measurements and the second set of measurements;
adjusting a third scan-data based on the error.

19. The computer-readable medium of claim 15, wherein the system captures scan-data at a predetermined frequency.

20. The computer-readable medium of claim 15, wherein the plane is identified automatically.
